(19) United States
(12) Patent Application Publication
(10) Pub. No.: US 2026/0167282 A1
(43) Pub. Date: Jun. 18, 2026

(54) STANDING PLATFORM FOR SKID STEER VEHICLE

(71) Applicant: Douglas Dynamics, L.L.C., Milwaukee, WI (US)

(72) Inventors: Michael Lee Frank, Thiensville, WI (US); Justin K. Hagelin, South Thomaston, ME (US); Craig D. MacIntosh, Thomaston, ME (US)

(21) Appl. No.: 19/356,423

(22) Filed: Oct. 13, 2025

Related U.S. Application Data
(60) Provisional application No. 63/735,635, filed on Dec. 18, 2024.

(51) Int. Cl. B62D 51/02; B62D 51/00; E01H 5/06

(52) U.S. Cl. CPC B62D 51/02; B62D 51/001; E01H 5/061

(57) ABSTRACT

A snow removal vehicle comprises a vehicle frame, a first pair of front and rear wheels mounted to one side of the frame and a second pair of front and rear wheels mounted to the other side of the frame, a power source, a transmission, and controls mounted on the frame and operable to selectively rotate the first and second pairs of wheels independently of one another in forward and reverse directions so as to allow for substantially zero radius turning of the vehicle about a zero-radius turning axis, and a standing platform mounted to a rearward end of the frame, the standing platform having a forward edge, a rearward edge, a first side edge, and a second side edge, the standing platform positioned entirely within a footprint of the vehicle.

### RELATED APPLICATIONS

This application claims priority to U.S. Provisional Ser. No. 63/735,635 filed Dec. 18, 2024 for STANDING PLATFORM FOR SKID STEER VEHICLE, which is hereby incorporated by reference herein as if fully set forth in its entirety. This application is related to but does not claim priority to U.S. patent application Ser. No. 19/201,247 filed May 7, 2025 for SNOW PLOW BLADE LIFT/LOWER SYSTEM FOR STAND-ON SKID STEER VEHICLE, which is hereby incorporated by reference herein as if fully set forth in its entirety.

### FIELD OF THE INVENTION

This invention relates generally to skid steer vehicles, and more particularly to stand-on skid steer vehicles with snow and ice control equipment mounted thereto.

### BACKGROUND OF THE INVENTION

Miniature stand-on skid steer vehicles have seen increased use as host vehicles for mounting snow plows for plowing small parking lots and sidewalks. The speed, maneuverability, and compact size of these vehicles makes them an ideal candidate for small scale snow plowing operations.

In typical current commercial offerings, the position of the standing platform places the operator further back on the machine, subjecting the operator to more centrifugal force during turning, exposing the operator to obstacles outside of the machine footprint, and reducing forward visibility of the operator.

Accordingly, further improvement in standing platforms for stand-on skid steer vehicles is desired.

### SUMMARY OF THE INVENTION

In one aspect, a vehicle comprises a vehicle frame, a first pair of front and rear wheels mounted to one side of the frame and a second pair of front and rear wheels mounted to the other side of the frame, a power source, a transmission, and controls mounted on the frame and operable to selectively rotate the first and second pairs of wheels independently of one another in forward and reverse directions so as to allow for substantially zero radius turning of the vehicle about a zero-radius turning axis, and a standing platform mounted to a rearward end of the frame, the standing platform having a forward edge, a rearward edge, a first side edge, and a second side edge, the standing platform positioned entirely within a footprint of the vehicle.

The forward edge of the standing platform can be positioned at or rearward of a forward vertical tangent of the rear wheels.

The rearward edge of the standing platform can be positioned at or forward of a rearward vertical tangent of the rear wheels.

The forward edge of the standing platform can be positioned at or rearward of a forward vertical tangent of the rear wheels and the rearward edge of the standing platform can be positioned at or forward of a rearward vertical tangent of the rear wheels.

The forward edge of the standing platform can be positioned rearward of the zero-radius turning axis of the vehicle.

The first side edge of the standing platform can be positioned adjacent an inner edge of one of the rear wheels and the second side edge of the standing platform can be positioned adjacent an inner edge of the other of the rear wheels.

The vehicle can further include a snow plow mounted to a forward end of the frame.

In another aspect, a vehicle comprises a vehicle frame, a first pair of front and rear wheels mounted to one side of the frame and a second pair of front and rear wheels mounted to the other side of the frame, a power source, a transmission, and controls mounted on the frame and operable to selectively rotate the first and second pairs of wheels independently of one another in forward and reverse directions so as to allow for substantially zero radius turning of the vehicle about a zero-radius turning axis, and a standing platform mounted to a rearward end of the frame, the standing platform having a forward edge, a rearward edge, a first side edge, and a second side edge, wherein the midway point between the forward edge and the rearward edge is forward of a rearward vertical tangent of the rear wheels.

In another aspect, a vehicle comprises a vehicle frame, a first pair of front and rear wheels mounted to one side of the frame and a second pair of front and rear wheels mounted to the other side of the frame, a power source, a transmission, and controls mounted on the frame and operable to selectively rotate the first and second pairs of wheels independently of one another in forward and reverse directions so as to allow for substantially zero radius turning of the vehicle about a zero-radius turning axis, and a standing platform mounted to a rearward end of the frame, the standing platform having a forward edge, a rearward edge, a first side edge, and a second side edge. The vehicle scribes a circle having a radius equal to the distance from the zero-radius turning axis to the radially extreme most portion of the vehicle when rotating around the zero-radius turning axis. The rearward edge of the standing platform is positioned within the circle, thereby avoiding striking any objects when rotating about the zero-radius turning axis.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is a rear, left, top perspective view of a stand-on skid steer vehicle according to the principles of the present invention.

FIG. 2 is a left side view thereof.

FIG. 3 is a rear view thereof.

FIG. 4 is a top view thereof.

FIG. 5 is a cross-sectional view taken along line 5-5 in FIG. 4.

### DETAILED DESCRIPTION OF THE DRAWINGS

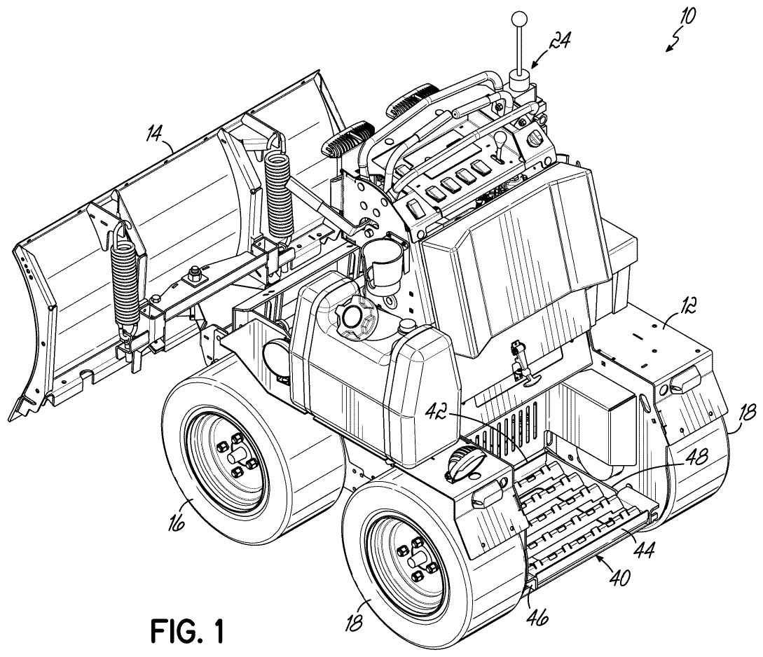

Referring to FIGS. 1-5, there is illustrated a stand-on skid steer vehicle 10 according to the principles of the present invention. The vehicle 10 has a frame 12. A snow plow 14 is mounted to a forward end of the frame 12. A first pair of front 16 and rear 18 wheels are mounted to one side of the frame 12 and a second pair of front 16 and rear 18 wheels are mounted to the other side of the frame 12.

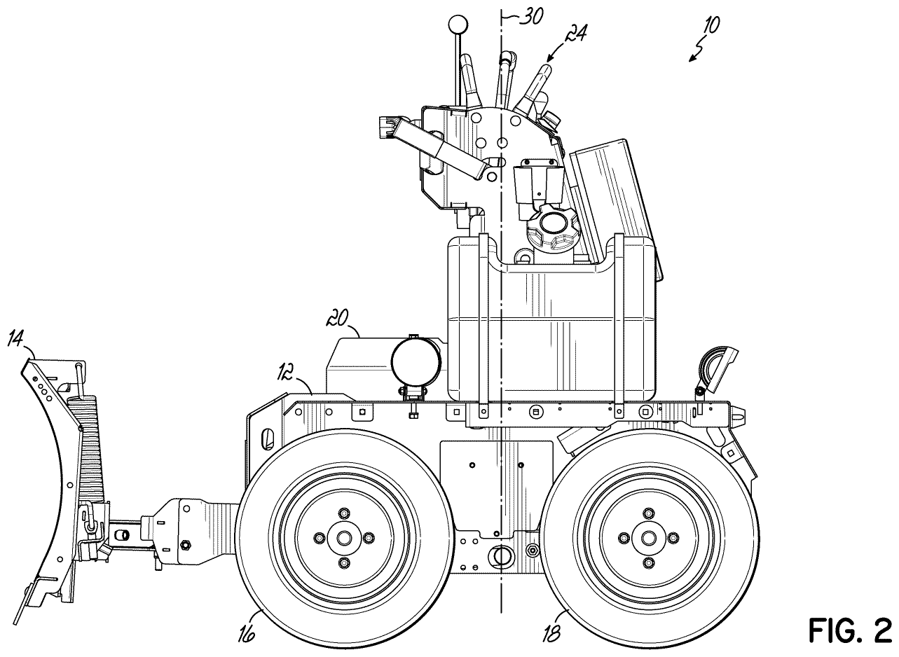

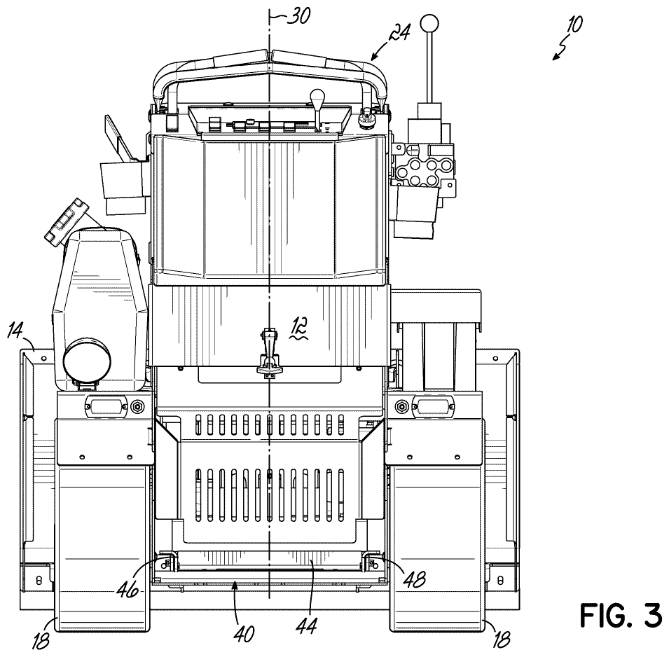

A power source or engine 20, a transmission 22 (for example hydraulic pump and wheel motors), and controls 24 are mounted on the frame 12. The engine 20, transmission 22, and controls 24 are operable to allow selective rotation of the first and second pairs of wheels 16, 18 independently of one another in forward and reverse directions. This allows for substantially zero radius turning of the vehicle 10 about a zero-radius turning axis 30 (FIGS. 2 and 3). Zero-radius turning axis 30 is located midway between the rotational axis of front wheels 16 and the rotational axis of the rear wheels 18, and midway between the first pair of wheels 16, 18 and the second pair of wheels 16, 18.

A standing platform 40 is mounted to a rearward end of frame 12. The platform has a forward edge 42, a rearward edge 44, a first side edge 46, and a second side edge 48. The platform 40 is sized, configured, and positioned on the frame 12, such that the platform 40 resides entirely within the footprint of the vehicle 10.

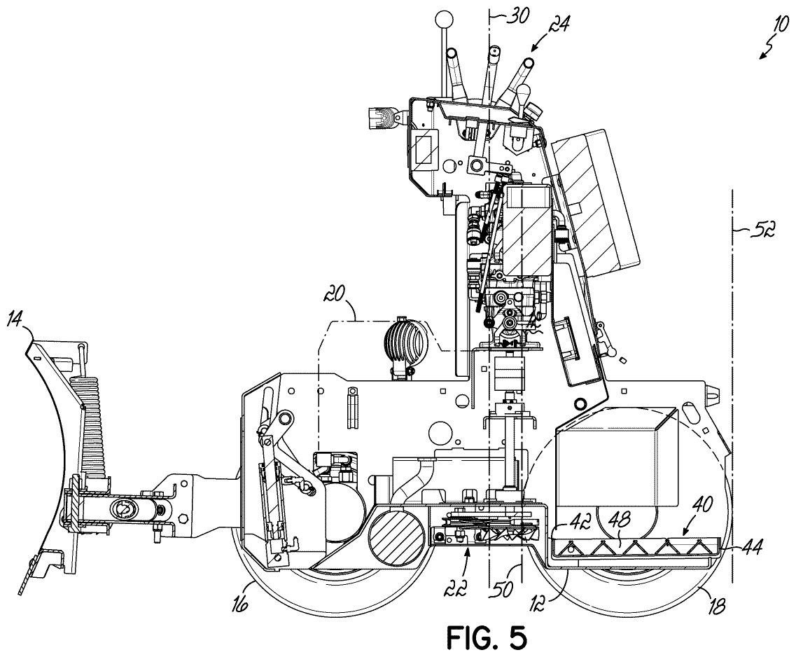

More particularly, and referring to FIG. 5, the forward edge 42 is positioned at or rearward of the forward vertical tangent 50 of the rear wheel 18, and the rearward edge 44 is positioned at or forward of the rearward vertical tangent 52 of the rear wheel 18. The forward edge 42 is thus positioned rearward of the zero-radius turning axis 30 of the vehicle 10. The first side edge 46 is positioned adjacent an inner edge of one rear wheel 18 and the second side edge 48 is positioned adjacent an inner edge of the other rear wheel 18. As such, the operator is positioned transversely midway between the rear wheels 18 and is positioned fore and aft midway between the forward 50 and rearward 52 vertical tangents of the rear wheels 18.

While the preferred embodiment of the present invention places the standing platform 40 within the footprint of the vehicle 10, other variations are within the scope of the present invention. For example, the midway point between the forward edge 42 and the rearward edge 44 of the standing platform 40 can be positioned forward of the rearward vertical tangents of the rear wheels 18. This provides many of the benefits of placing the standing platform 40 within the footprint of the vehicle 10.

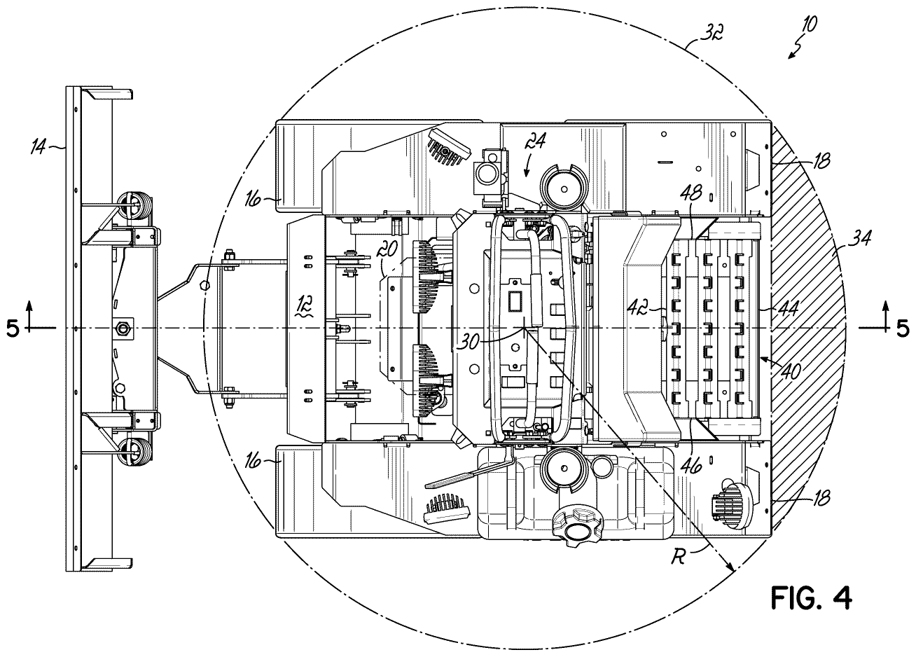

As another example, when the vehicle 10 rotates around the zero-radius turning axis, the vehicle 10 scribes a circle 32 having a radius R equal to the distance from the zero-radius turning axis 30 to the radially extreme most portion of the vehicle (whether wheels/tires or frame). See FIG. 4. The rearward edge 44 of the standing platform 40 can be positioned within that circle 32. More particularly, the rearward edge 44 can be configured/positioned to occupy any portion or the entire portion of the shaded area 34. The rearward edge 44 can be straight as in the prior embodiment, or it can be curved having a radius of curvature equal to the radius R of the scribed circle 32, or it can be other shapes. This provides many of the benefits of placing the standing platform 40 within the footprint of the vehicle 10, and provides the additional benefit of the rearward edge 44 of the standing platform 40 not contacting any objects while the vehicle 10 rotates/turns about the zero-radius turning axis 30.

The vehicle and standing platform of the present invention places the operator forward on the machine, subjecting the operator to less centrifugal force during turning, protecting the operator from obstacles outside of the machine footprint, and increasing forward visibility of the operator. Reducing the centrifugal force on the operator makes it easier for the operator to maintain a firm grip on the machine. Placing the operator forward on the machine improves visibility for tools attached to the front of the machine and awareness of their location to objects such as buildings and poles as well as pedestrians. An additional benefit is during backing up or reversing of the machine, the first part of the machine to strike an object such as a building wall is the tires and not the standing platform, thus reducing damage to the machine and providing a cushioned stop in the reverse direction rather than a sudden jolt.

In addition to snow plows, granular snow/ice melt material spreaders and brine sprayers could be mounted to the vehicle for additional snow and ice control. And, implements or tools other than snow plows (whether straight blade or V-blade) can be mounted to the vehicle for use therewith. For example, the vehicle could be used with most any mini skid steer attachment such as brooms, snow blowers/throwers, snow pushers (also known as box plows or containment plows), etc. In addition, other implements, tools, or attachments, not related to snow and ice control, can be mounted to the vehicle for four season use.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. The invention resides in each individual feature described herein, alone, and in any and all combinations and subcombinations of any and all of those features. Accordingly, the scope of the invention shall be limited only by the following claims and their equivalents.

What is claimed is:

1. A vehicle, comprising:
a vehicle frame,
a first pair of front and rear wheels mounted to one side of said frame and a second pair of front and rear wheels mounted to the other side of said frame,
a power source, a transmission, and controls mounted on said frame and operable to selectively rotate said first and second pairs of wheels independently of one another in forward and reverse directions so as to allow for substantially zero radius turning of said vehicle about a zero-radius turning axis, and
a standing platform mounted to a rearward end of said frame, said standing platform having a forward edge, a rearward edge, a first side edge, and a second side edge, said standing platform positioned entirely within a footprint of said vehicle.

2. The vehicle of claim 1, wherein said forward edge of said standing platform is positioned at or rearward of a forward vertical tangent of said rear wheels.

3. The vehicle of claim 1, wherein said rearward edge of said standing platform is positioned at or forward of a rearward vertical tangent of said rear wheels.

4. The vehicle of claim 1, wherein said forward edge of said standing platform is positioned at or rearward of a forward vertical tangent of said rear wheels and said rearward edge of said standing platform is positioned at or forward of a rearward vertical tangent of said rear wheels.

5. The vehicle of claim 1, wherein said forward edge of said standing platform is positioned rearward of the zero-radius turning axis of said vehicle.

6. The vehicle of claim 1, wherein said first side edge of said standing platform is positioned adjacent an inner edge of one of said rear wheels and said second side edge of said standing platform is positioned adjacent an inner edge of the other of said rear wheels.

7. The vehicle of claim 1 further comprising a snow plow mounted to a forward end of said frame.

8. A vehicle, comprising:
a vehicle frame,
a first pair of front and rear wheels mounted to one side of said frame and a second pair of front and rear wheels mounted to the other side of said frame,
a power source, a transmission, and controls mounted on said frame and operable to selectively rotate said first and second pairs of wheels independently of one another in forward and reverse directions so as to allow for substantially zero radius turning of said vehicle about a zero-radius turning axis, and
a standing platform mounted to a rearward end of said frame, said standing platform having a forward edge, a rearward edge, a first side edge, and a second side edge,
wherein the midway point between said forward edge and said rearward edge is forward of a rearward vertical tangent of said rear wheels.

9. The vehicle of claim 8 further comprising a snow plow mounted to a forward end of said frame.

10. A vehicle, comprising:
a vehicle frame,
a first pair of front and rear wheels mounted to one side of said frame and a second pair of front and rear wheels mounted to the other side of said frame,
a power source, a transmission, and controls mounted on said frame and operable to selectively rotate said first and second pairs of wheels independently of one another in forward and reverse directions so as to allow for substantially zero radius turning of said vehicle about a zero-radius turning axis, and
a standing platform mounted to a rearward end of said frame, said standing platform having a forward edge, a rearward edge, a first side edge, and a second side edge,
the vehicle, when rotating around the zero-radius turning axis, scribing a circle having a radius equal to the distance from the zero-radius turning axis to the radially extreme most portion of the vehicle,
wherein said rearward edge of said standing platform is positioned within the circle, thereby avoiding striking any objects when rotating about the zero-radius turning axis.

11. The vehicle of claim 10 further comprising a snow plow mounted to a forward end of said frame.
